(19) United States
(12) Patent Application Publication
(10) Pub. No.: US 2026/0202520 A1
(43) Pub. Date: Jul. 16, 2026

(54) SYSTEMS AND METHODS FOR MULTIMODE QUANTUM LIDAR

(71) Applicant: Northrop Grumman Systems Corporation, Falls Church, VA (US)

(72) Inventors: Michael M. Fitelson, Columbia, MD (US); Scott Kelber, Columbia, MD (US); Sean P. Kelley, Rolling Meadows, IL (US); Yanhua Shih, Ellicott City, MD (US)

(21) Appl. No.: 19/014,694

(22) Filed: Jan. 9, 2025

(51) Int. Cl. G01S 7/4911; G01S 7/481; G01S 7/4913; G01S 17/32; G01S 17/89

(52) U.S. Cl. CPC G01S 7/4911; G01S 7/4818; G01S 7/4913; G01S 17/32; G01S 17/89

(57) ABSTRACT

A multimode quantum LIDAR system can include a beam generator configured to generate a transmit beam comprising a plurality of modes, an optical element configured to generate a reference beam from the transmit beam, a detector configured to receive a reflected beam from the transmit beam, and a digital converter. The digital converter can be configured to convert the reference beam into a digital reference waveform and convolve the digital reference waveform with a representation of the received beam, based on the plurality of modes of the transmit beam.

### FIELD

The present disclosure relates generally to LIDAR systems, and more particularly to quantum LIDAR systems.

### BACKGROUND

LIDAR is a type of sensing technology that can provide range-finding and/or imaging based on a laser. As an example, a LIDAR system can determine distances and/or ranges of an object by targeting the object with a laser and measuring a time for the reflected light to return to a receiver. A LIDAR system can also be used to create digital three-dimensional images of areas on terrestrial surfaces, on the ocean floor, and/or structures (e.g., buildings) thereon due to differences in laser return times and by varying laser wavelengths. However, modern systems are insufficient in many ways that are addressed by example embodiments described below.

### SUMMARY

Aspects and advantages of the present disclosure will be set forth in part in the following description, or may be obvious from the description, or may be learned through practice of the present disclosure.

In one embodiment, a multimode quantum LIDAR system includes a beam generator that is configured to generate a transmit beam comprising a plurality of modes. The system can include an optical element configured to generate a reference beam from the transmit beam. The system can include a detector configured to receive a reflected beam from the transmit beam. The system can include a digital converter that is configured to convert the reference beam into a digital reference waveform and convolve the digital reference waveform with a representation of the received beam based on the plurality of modes of the transmit beam.

In one embodiment, a method for multimode quantum LIDAR includes generating, using a beam generator, a transmit beam comprising a plurality of modes. The method includes generating, using an optical element, a reference beam from the transmit beam. The method includes receiving, using a detector, a reflected beam from the transmit beam. The method includes converting, using a digital converter, the reference beam into a digital reference waveform. The method includes convolving the digital reference waveform with a representation of the received beam based on the plurality of modes of the transmit beam.

### BRIEF DESCRIPTION OF THE DRAWINGS

A full and enabling disclosure of the present disclosure directed to one of ordinary skill in the art, is set forth in the specification, which makes reference to the appended figures.

FIG. 1 illustrates an example block diagram of a quantum LIDAR system.

FIG. 2 illustrates another example block diagram of a quantum LIDAR system.

FIG. 3 shows an example convolution output graph that can be generated by one or more system elements described herein, such as by the convolution module.

FIG. 4 illustrates an example method for generating LIDAR data associated with a target.

### DETAILED DESCRIPTION

Reference now will be made in detail to embodiments of the disclosure, one or more examples of which are illustrated in the drawings. Each example is provided by way of explanation of the disclosure, not limitation of the disclosure. In fact, it will be apparent to those skilled in the art that various modifications and variations can be made in the present disclosure without departing from the scope or spirit of the disclosure. For instance, features illustrated or described as part of one embodiment can be used with another embodiment to yield a still further embodiment. Thus, it is intended that the present disclosure covers such modifications and variations as come within the scope of the appended claims and their equivalents.

The present invention relates generally to LIDAR systems, and specifically to a quantum LIDAR systems. Quantum LIDAR systems can be implemented for any of a variety of applications for range-finding and/or imaging. The LIDAR system can include a fiber that is excited by a laser. The fiber can generate a plurality of modes. These modes can be correlated and/or measured.

In some embodiments, two or more photons can have wavefunction properties when a fiber cavity is excited by an input laser. The laser may include a narrow band laser. A small sample of the output beam is used to create a reference waveform. The reference waveform can be detected and/or digitized to produce a time record of one or more samples. The one or more samples may be sampled at a rate fast enough to get close to a correlation peak associated with coincidence measurements between returning photon detections and the intensity fluctuations of the reference waveform.

In some embodiments, the system can include a long-range quantum LIDAR system that can be implemented without the need for non-linear optics. For example, the system may be able to transmit signals using the same or comparable amount of power as a classical LIDAR system. Additionally, or alternatively, such systems may be able to achieve a performance of 2-3 times the range as those systems. For example, the systems can achieve this functionality in severe noise conditions and/or may cancel out phase effects of atmospheric turbulence.

The systems described herein can use quantum mechanical properties of photons. For example, when a fiber optic cavity is excited by a narrow band laser, a collection of narrow band modes can be created. The photons within each mode can have nearly identical properties. When individual photons return from a target object, the photons can be correlated against intensity fluctuations of a digitized reference beam. The reference beam can be formed from a small sample of the output beam. Returning photons can be in a superposition state of the modes and/or can correlate against the intensity fluctuations of the reference waveform when mathematical terms (e.g., t-R/c, where R is a total distance to a target and back, and c is the speed of light) associated with the returning photon(s) line up with the correct reference waveform time samples. These correlations can form a histogram peak close to a theoretical maximum. The intensity fluctuations for the reference waveform can be generated by calculating the mean value of its intensity over a large number of samples and subtracting the mean value from each time sample over the range of values of interest.

In some embodiments, multiple fiber cavities can be combined to create higher power beams. One or more high-powered laser and/or splitters can be included in such embodiments.

In some embodiments, bulk crystal optical parametric oscillators can be used to generate one or more modes. However, preferably a higher number of modes are created to improve the accuracy and/or signal-to-noise (SNR) of the system. Modern systems are generally able to provide a limited number of modes due to frequency and/or length constraints. Additionally, or alternatively, existing systems employ optical elements with low power channels. Systems described herein can provide a plurality of modes while maintaining a manageable bandwidth. Additionally, or alternatively, the systems can take advantage of low-loss fibers that can support the use of longer lengths to excite multiple modes. Traditional systems that employ pulsed waveforms are generally limited by severe noise and atmospheric turbulence.

By contrast, using quantum correlations described herein, such as those associated with coherent state multimode quantum LIDAR systems, can significantly mitigate shortfalls of modern systems.

In some embodiments, a stable continuous wave laser can be used to excite multiple modes of the laser. These modes can display strong correlations with returning photon detections based on their two-photon properties. These two-photon properties can allow the reference waveform correlations against noise and turbulence to cancel the noise and resist the effects of turbulence.

The quantum LIDAR system can include a beam generator that is configured to generate a transmit beam comprising a plurality of modes. A reference beam can be generated from the transmit beam. For example, an optical element (e.g., pellicle), such as a beam splitter, can redirect a portion of the transmit beam to be used as the reference beam. In some embodiments, the quantum LIDAR system can include a beam combiner that is configured to combine the transmit beam and the reference beam to generate a combined optical beam. The beam combiner can be configured as a set of optics that can generate the combined optical beam and provide the combined optical beam to a LIDAR transmitter and/or to a LIDAR receiver.

The LIDAR receiver can be configured to receive a combined optical beam from a target. The combined optical beam can include the reference beam and a reflected beam. The transmit optical beam can be reflected from the target to provide the reflected beam. The LIDAR receiver can generate LIDAR data associated with the target based on the reference beam and the reflected beam. For example, the LIDAR receiver can include a LIDAR processor that can convolve a digital reference waveform corresponding to the reference beam with a representation of the received beam based on a plurality of band modes of the transmit beam. In some embodiments, the LIDAR processor can be configured to receive individual photons. For example, the reflected beam may consist of only a small number (e.g., fewer than 20, fewer than 50, fewer than 100, etc.) of reflected photons. Based on the convolution of the reflected (e.g., signal) with the reference beam at the LIDAR receiver, the LIDAR processor can greatly increase a signal-to-noise ratio (SNR) of the resultant LIDAR data based on determining a convolution peak from the convolution.

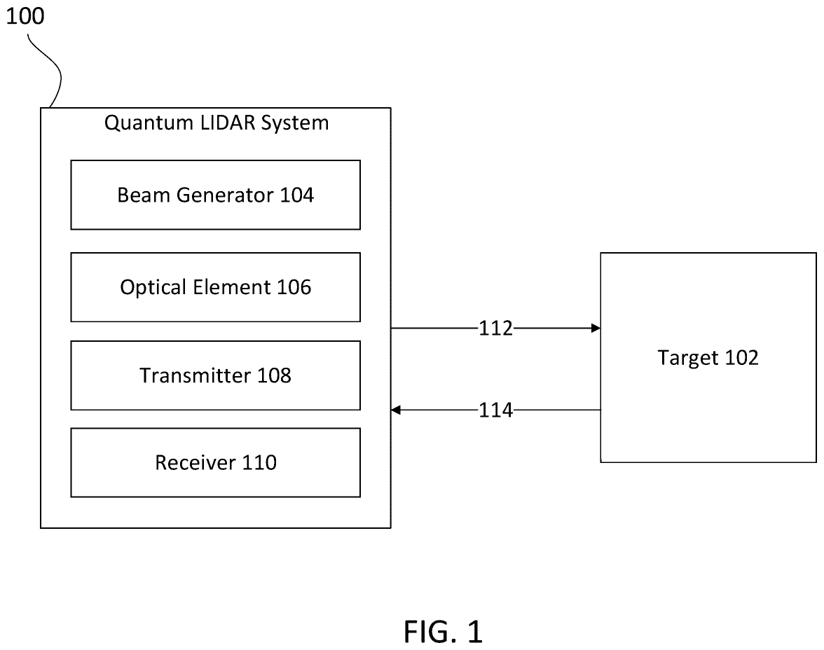

FIG. 1 illustrates an example block diagram of a quantum LIDAR system 100. The quantum LIDAR system 100 can be implemented in any of a variety of range-finding and/or imaging applications with respect to a target 102. The target 102 can correspond to geographic features (e.g., terrestrial, underwater, and/or surfaces of other celestial bodies) or to man-made structures, such as buildings or vehicles. Thus, the quantum LIDAR system 100 can be configured to determine a range to the target 102 and/or generate image data associated with the target 102.

The quantum LIDAR system 100 includes a beam generator 104, an optical element 106. The beam generator 104 is configured to generate a transmit beam 112 comprising a plurality of modes that can be implemented in a multimode beam. The optical element 106 can be configured to generate a reference beam from the transmit beam 112. The reference beam and the transmit beam can have a common wavefront. As an example, the optical element 106 can include a variety of different types of optical devices to split the reference beam from the transmit beam 112. For example, the optical element 106 can include a beam splitter and/or other refractive and/or reflective optical element. For example, in some embodiments, the optical element 106 includes a pellicle. As described herein, the optical element 106 can generate the reference beam such that the transmit beam 112 and the reference beam have one or more of the same modes. The quantum LIDAR system 100 can include a fiber laser to generate the multimode transmit beam.

The transmitter 108 can be configured to transmit the transmit beam 112 to the target 102. The LIDAR receiver 110 can be configured to receive the received beam 114, which may be reflected from the target 102 and which may include information indicative of a distance of the target 102 from the receiver 110. The received beam 114 (e.g., reflected beam) and/or the reference beam can be received by the LIDAR receiver 110. For example, in some embodiments the LIDAR receiver 110 receives both the reference beam and the received beam 114, such that the LIDAR receiver 110 is configured to generate LIDAR data associated with the target 102 based on the reference beam and the received beam 114. As an example, the LIDAR receiver 110 can include a LIDAR processor that is configured to implement a temporal convolution algorithm on the reference beam and the received beam 114 to generate the LIDAR data associated with the target 102. The temporal convolution algorithm can include determining one or more intensities (e.g., a mean intensity) associated with the reference beam. For example, photons of the received beam 214 can be in a superposition state of all the modes and submodes, so that the electric field of a single photon can be mathematically represented based on a combination of all of the modes and submodes. In some embodiments, determining one or more intensities can include determining an intensity associated with each of the plurality of modes.

As an example, the LIDAR receiver 110 can include a local detector that is configured to monitor the reference beam and a target detector that is configured to monitor the received beam 114. The local detector of the LIDAR receiver 110 can agnostically detect one of the received beam 114 and/or the reference beam in the reference beam, and the target detector of the LIDAR receiver can agnostically detect the other one of the received beam 114 and the reference beam in the received beam 114. As a result, the LIDAR processor can implement the temporal convolution algorithm in a manner that increases signal-to-noise ratio (SNR) for a stronger correlation between the reference beam and the received beam 114.

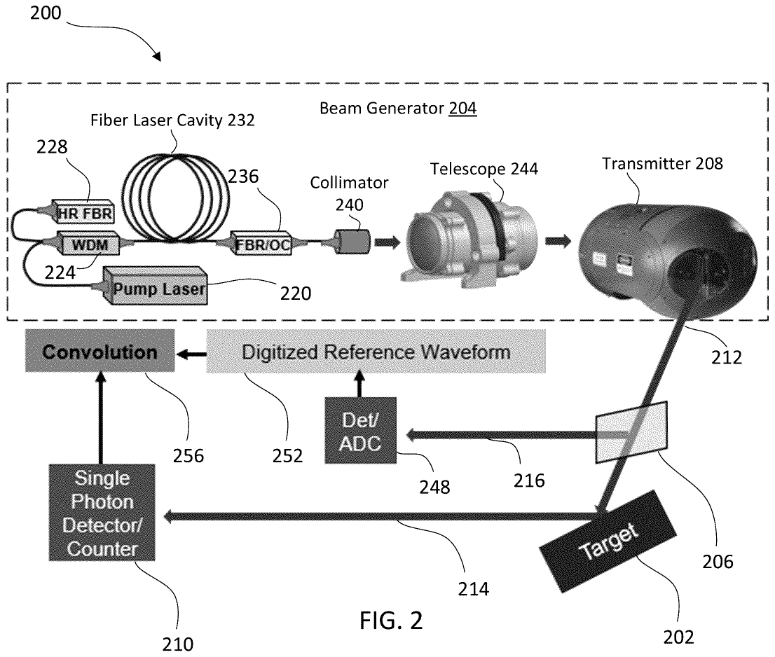

FIG. 2 illustrates another example block diagram of a quantum LIDAR system 200. The quantum LIDAR system 200 can correspond to the quantum LIDAR system 100 in the example of FIG. 1. Therefore, reference is to be made to the example of FIG. 1 in the following description of the example of FIG. 2.

The quantum LIDAR system 200 includes a beam generator 204, an optical element 206, a single photon detector 210, and/or an analog-to-digital converter 248. The beam generator 204 can include a pump laser 220, a wavelength division multiplexer 224, a high-reflectivity fiber Bragg reflector 228, a fiber laser cavity 232, an output coupler 236, a collimator 240, a telescope 244, and/or a transmitter 208.

The pump laser 220 can include a continuous wave laser. The pump laser 220 can provide high stability, narrow linewidth, and/or precise control over the output used to generate the transmit beam 212. The pump laser 220 can include a fiber laser, a diode-pumped solid-state (DPSS) laser, and/or one or more other lasers that can generate a stable and/or continuous wave beam. In some embodiments, the pump laser 220 can generate wavelengths in the infrared range (e.g., between about 1064 nm and about 1550 nm). Infrared light may be advantageous because it is resistant to atmospheric absorption and/or can be eye-safe.

The pump laser 220 can be configured to maintain phase coherence throughout the entire beam generator 204. The pump laser 220 may be tuned and/or locked to specific frequencies in order to generate a target number and/or frequency of modes.

The wavelength division multiplexer 224 can receive the light from the pump laser 220. The wavelength division multiplexer 224 can provide low insertion loss to preserve coherence of the light beam from the pump laser 220. The wavelength division multiplexer 224 can include one or more thin-film filters and/or arrayed waveguide gratings (AWG). The AWG can be configured for refracting the wavelength(s) of light of the pump laser 220. The wavelength division multiplexer 224 can separate out undesired photons, reduce dispersion (e.g., polarization mode dispersion (PMD)).

The fiber laser cavity 232 can be configured to generate a plurality of modes. For example, the fiber laser cavity 232 may be long enough to generate at least 10 modes, though higher modes are possible (e.g., 20, 50, 100, 500, 1000, etc.). To generate these modes, the fiber laser cavity 232 can be long, for example at least 1 m long. The number of possible modes is related to the length of the fiber laser cavity 232. In some embodiments, the fiber laser cavity 232 may be at least 10 m, at least 20 m, at least 30 m, at least 50 m, at least 100 m, at least 250 m, at least 500 m, at least 1,000 m, at least 5,000 m, at least 10,000 m, any value therein, or fall within a range having endpoints therein. The fiber laser cavity 232 may be configured to have a broad range of frequency modes. For example, a difference between a highest frequency and lowest frequency of the plurality of modes may be at least 0.5 GHz, at least 1 GHz, at least 1.5 GHz, at least 2 GHz, at least 2.5 GHz, at least 3.5 GHz, at least 5 GHz, any value therein, or fall within a range having endpoints therein.

The output coupler 236 can include a high-reflectivity Fiber Bragg Grating (FBG). The output coupler 236 can filter out and/or reflect specific wavelengths of light from and/or within the fiber laser cavity 232 while allowing other wavelengths to pass. The output coupler 236 may be inscribed into a core of a fiber laser cavity 232. The output coupler 236 can create periodic variations in the refractive index of the fiber laser cavity 232. The output coupler 236 can cause selective reflection of the laser light based on the wavelength(s) of the pump laser 220. The reflected light may be determined by the grating period of the output coupler 236.

The output coupler 236 may be configured to trap the multimode signal to create a stable feedback loop for the pump laser 220. The output coupler 236 may be configured for the wavelength of the pump laser 220.

The collimator 240 may receive light from the output coupler 236 to collimate the light. The collimated light can be transmitted to the telescope 244. The telescope 244 can include a plurality of optical elements configured to steer the beam. The telescope 244 can be configured to transmit to and/or receive light from the target 202. The beam steering may be done mechanically (e.g., with rotating mirrors) and/or using optical phased arrays for non-mechanical scanning.

The beam generator 204 can be configured to generate a transmit beam 212 that can be implemented in a multimode beam. As an example, the transmit beam 212 can be generated with a plurality of modes. For example, the fiber laser cavity 232 can be sufficiently long to allow for the generation of a plurality of modes above a certain threshold number of modes. For example, the threshold number of modes can be 10 modes, 20 modes, 30 modes, 50 modes, quantum LIDAR system 100 modes, 250 modes, any number of modes therein, or fall within a range having endpoints therein. For example, in some embodiments, the number of modes is at least 10 modes. Having fewer than 10 modes would likely not be able to achieve a sufficient accuracy of the quantum LIDAR system 200 because the convolution may not result in a sufficient SNR and/or accuracy.

The beam generator 204 can cause the transmit beam 212 to be transmitted via the transmitter 208 (e.g., via one or more optical elements). The LIDAR transmitter 208 is configured to illuminate a target 202 with the reference beam. The transmit beam 212 is thus reflected from the target and provided back to quantum LIDAR system 200 (e.g., the single photon detector 210) as a received beam 214. The single photon detector 210 can be a part of the LIDAR receiver 110. The single photon detector 210 can convert the received beam 214 to a representation of the received beam 214. The representation of the received beam 214 can include one or more digital signal waveforms. Additionally, or alternatively, the analog-to-digital converter 248 can convert the reference beam 216 to a digital reference waveform 252.

The quantum LIDAR system 200 (e.g., the single photon detector 210, the analog-to-digital converter 248, a separate computing system) can perform a convolution using the convolution module 256. The convolution can include calculating a total electric field of the reference beam 216 by summating an electric field associated with each of the plurality of modes of the reference beam 216. The convolution can include summating all the products of intensity of delayed versions of the digital reference waveform 252 associated with the reference beam 216. The summated products can be compared against intensity values of corresponding summated products of the representation (e.g., digitized waveform) of the received beam 214. In some embodiments, all the modes of both waveforms contribute to the convolution. In some embodiments, convolving the digital reference waveform 252 with the representation of the received beam 214 can include subtracting a mean intensity from an intensity of at least one mode associated with the received beam 214. This approach may be particularly valuable, for example, when the received beam 214 includes a continuous waveform rather than discrete photons.

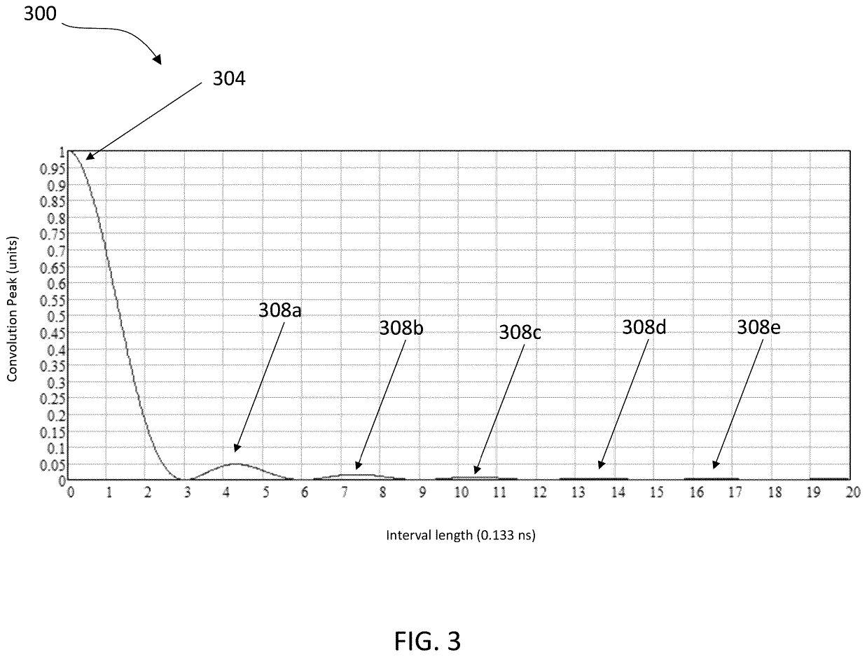

In some embodiments, determining the mean intensity for the reference beam can include determining a plurality of mean intensities for a plurality of reference beams. It may be beneficial to sample intensity fluctuations of the digital reference waveform 252 and photon detections fast enough so that a time offset at a peak of the convolution is sufficiently close to (e.g., within a threshold time from) a maximum theoretical value. Accordingly, in some embodiments the convolution module 256 and/or other elements of the quantum LIDAR system 200 can be configured to determine the plurality of mean intensities for a plurality of reference beams at least at a sampling interval sufficient to correlate intensity fluctuations of the digital reference waveform 252 with the received beam 214. Using a correct time offset can allow a determination of the distance of the target 202 from the quantum LIDAR system 200. For example, in a 1.25 km long fiber laser cavity 232 with 30,000 modes spanning 2.5 GHz, 1.25 GHz on each side of the center frequency, with a mode spread of ±11.67 KHz, the sampling interval may be about 0.1333 ns (see FIG. 3).

In some embodiments, such as when single photons are detected by the single photon detector 210, the quantum LIDAR system 200 may, prior to forming the convolution, set a threshold correlation value for each photon event with the reference waveform. This threshold correlation value may be a normalized value between 0 and 1. Additionally, or alternatively, the mean value of the reference waveform may be normalized to 1, since the mean value may factor out in the calculation. In some embodiments, the threshold correlation value may be configured to reduce a minimum percentage and/or ratio of noise photons relative to signal photons. The threshold can be set based on one or more products obtained from the convolution between the digital reference waveform 252 and a representation of the received beam 214. Additionally, or alternatively, the threshold can be set based on statistics of individual correlations between single photon events (e.g., from the received beam 214) and the reference waveform 252. When the signal photons are aligned to the correct time slots the signal photon correlation statistics are different from the noise correlation statistics.

In some embodiments, the average value of the noise and digital reference waveform 252 correlations can be calculated in the absence of signals and later subtracted from the convolution of the digital reference waveform 252 with the signal and noise photons, which may increase a probability of detection of the signal. In the case of multiple reference beams, the beams can be coherently combined, applying one or more steps described above. The mean value of a sum of the noise correlations of the combined digital reference waveform 252 and the noise photon events can be subtracted from the convolutions of the digital reference waveform 252 with all the photon detection values.

The convolution module 256 may be configured to select a convolution value for when the time values correlate between the received beam 214 and the reference beam 216. If the photons from the received beam 214 and the reference beam 216 align timewise, then a peak of intensity will be at a particular time (see, e.g., FIG. 3). The quantum LIDAR system 200 can correlate the received beam 214 with the reference beam 216 by selecting a time offset in the convolution that produces such a peak.

The convolution module 256 can extract information about the target 202 by comparing the received beam 214 (e.g., via a representation thereof) to the reference beam 216 (e.g., via the digital reference waveform 252). Each beam may have distinct spatial, frequency, and/or polarization modes. When the received beam 214 and the reference beam 216, each containing multiple modes, are compared using the convolution module 256, the convolution module 256 performs a form of mode-matching. In some embodiments, the convolution includes calculating an overlap integral of each of the modes of the received beam 214 with those of the reference beam 216.

If the modes are well-matched, the resulting correlation value can exceed a threshold correlation value, such as a normalized correlation value. In some embodiments, the threshold normalized correlation value is 0.6. Other threshold normalized correlation values are possible. If the threshold normalized correlation value is not met, the quantum LIDAR system 200 can determine that the received beam 214, which may include one or more single photons, does not correspond to a signal but rather to noise. If the quantum LIDAR system 200 determines that the correlation value exceeds the threshold correlation value, then the quantum LIDAR system 200 can determine distance information associated with the target 202, such as how far away from the quantum LIDAR system 200 the target 202 is.

Such mode-wise convolution can allow the quantum LIDAR system 200 to extract information from the transmit beam 212 about the properties of the target 202, such as distance, velocity, and/or even surface characteristics thereof. Different modes may carry different aspects of the information.

The single photon detector 210 and/or the convolution module 256 can include a LIDAR processor that is configured to implement the convolution algorithm (e.g., temporal convolution algorithm) on the received beam 214 and the reference beam 216 to generate the LIDAR data associated with the target 202. The convolution algorithm can be a delayed choice detection algorithm, such that the temporal convolution algorithm can be implemented at a time after receipt of the received beam 214. In some embodiments, the single photon detector 210 and/or convolution module 256 can convert single photons to a representation of discrete points and summate intensity values associated with the discrete points.

FIG. 3 shows an example convolution output graph 300 that can be generated by one or more system elements described herein, such as by the convolution module 256. As shown, the convolution output graph 300 can generate a convolution main peak 304 at a first time (e.g., time=0), with one or more convolution minor peaks 308a-e corresponding to additional modes of the received beam (e.g., received beam 114, received beam 214). Each number along the x-axis may correspond to a unit of intervals, each with an interval length (e.g., 0.133 ns). Based on the known time associated with the convolution main peak 304, the convolution output graph 300 can determine a distance that a target element is from the system.

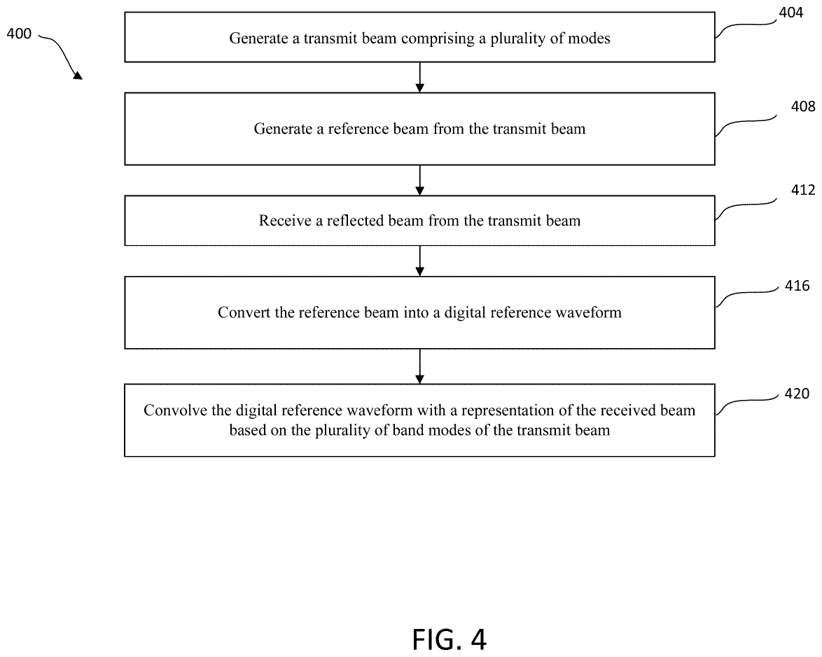

FIG. 4 illustrates an example method 400 for generating LIDAR data associated with a target (e.g., the target 102, the target 202). The steps may be performed by any system (e.g., quantum LIDAR system 100, quantum LIDAR system 200) or part of a system described herein. It is to be understood and appreciated that the method of FIG. 4 is not limited by the illustrated order, as some aspects could, in accordance with the present disclosure, occur in different orders and/or concurrently with other aspects from that shown and described herein. Moreover, not all illustrated features may be required to implement a methodology in accordance with an aspect of the present examples.

At 404, the system generates a transmit beam comprising a plurality of modes. At 408, the system generates a reference beam from the transmit beam. The transmit beam can be directed at a target. At 412, the system can receive a reflected beam from the transmit beam. The reflected beam may be a received beam from the target. At 416, the system can convert the reference beam into a digital reference waveform and, at 420, convolve the digital reference waveform with a representation of the received beam based on the plurality of band modes of the transmit beam.

What have been described above are examples of the present invention. It is, of course, not possible to describe every conceivable combination of components or methodologies for purposes of describing the present invention, but one of ordinary skill in the art will recognize that many further combinations and permutations of the present invention are possible. Accordingly, the present invention is intended to embrace all such alterations, modifications and variations that fall within the spirit and scope of the appended claims. Additionally, where the disclosure or claims recite “a,” “an,” “a first,” or “another” element, or the equivalent thereof, it should be interpreted to include one or more than one such element, neither requiring nor excluding two or more such elements. As used herein, the term “includes” means includes but not limited to, and the term “including” means including but not limited to. The term “based on” means based at least in part on.

This written description uses examples to disclose the disclosure, including the best mode, and also to enable any person skilled in the art to practice the disclosure, including making and using any devices or systems and performing any incorporated methods. The patentable scope of the disclosure is defined by the claims, and may include other examples that occur to those skilled in the art. Such other examples are intended to be within the scope of the claims if they include structural elements that do not differ from the literal language of the claims, or if they include equivalent structural elements with insubstantial differences from the literal languages of the claims.

What is claimed is:

1. A multimode quantum LIDAR system comprising:
a beam generator configured to generate a transmit beam comprising a plurality of modes;
an optical element configured to generate a reference beam from the transmit beam;
a detector configured to receive a beam reflected from the transmit beam; and
a digital converter configured to:
convert the reference beam into a digital reference waveform; and
convolve the digital reference waveform with a representation of the received beam based on the plurality of modes of the transmit beam.

2. The system of claim 1, wherein the beam generator comprises:
a fiber cavity having a length greater than a minimum threshold length configured to generate a minimum threshold number of modes; and
a continuous wave laser configured to pump the fiber cavity.

3. The system of claim 2, wherein at least one of:
the minimum threshold length of the fiber cavity is at least 1 m; or
the minimum threshold number of modes is at least 10.

4. The system of claim 1, wherein the optical element comprises a reflective optical element.

5. The system of claim 4, wherein the reflective optical element comprises a pellicle.

6. The system of claim 1, wherein convolving the digital reference waveform with the representation of the received beam comprises:
determining a mean intensity for the reference beam associated with each of the modes.

7. The system of claim 6, wherein determining the mean intensity for the reference beam comprises:
calculating a total electric field of the reference beam by summating an electric field associated with each of the plurality of modes.

8. The system of claim 6, wherein convolving the digital reference waveform with the representation of the received beam comprises:
subtracting a mean intensity associated with one or more noise photons from a convolution of the digital reference waveform.

9. The system of claim 6, wherein convolving the digital reference waveform with the representation of the received beam comprises:
determining whether a convolution between the digital reference waveform and the representation of the received beam exceeds a threshold value.

10. The system of claim 6, wherein determining the mean intensity for the reference beam comprises determining a plurality of intensities for a plurality of reference beams at a sampling interval.

11. The system of claim 10, wherein the sampling interval is less than 0.5 ns.

12. A method for multimode quantum LIDAR, the method comprising:
generating, using a beam generator, a transmit beam comprising a plurality of modes;
generating, using an optical element, a reference beam from the transmit beam;
receiving, using a detector, a beam reflected from the transmit beam;
converting, using a digital converter, the reference beam into a digital reference waveform; and
convolving the digital reference waveform with a representation of the received beam based on the plurality of modes of the transmit beam.

13. The method of claim 12, wherein generating the transmit beam comprises:
pumping, using a continuous wave laser, a fiber cavity having a length greater than a minimum threshold length configured to generate a minimum threshold number of modes.

14. The method of claim 13, wherein the minimum threshold length of the fiber cavity is at least 1 m.

15. The method of claim 12, wherein the optical element comprises a beam splitter.

16. The method of claim 15, wherein the beam splitter comprises a pellicle.

17. The method of claim 12, wherein convolving the digital reference waveform with the representation of the received beam comprises:
determining a mean intensity for the reference beam associated with each of the modes.

18. The method of claim 17, wherein determining the mean intensity for the reference beam comprises:
measuring the intensity of each time sample of the reference beam which is a combined intensity of the modes and averaged over many samples.

19. The method of claim 17, wherein determining the mean intensity for the reference beam comprises:
determining a plurality of mean intensities for a plurality of reference beams, and wherein determining the plurality of mean intensities for a plurality of reference beams is at a rate sufficient to correlate intensity fluctuations of the digital reference waveform with the received beam.

20. The method of claim 12, wherein a difference between a highest frequency and lowest frequency of the plurality of modes is at least 1 GHz.
